(19) United States
(12) Patent Application Publication
(10) Pub. No.: US 2024/0314556 A1
(43) Pub. Date: Sep. 19, 2024

(54) AUGMENTED SUBSCRIBER AUTHENTICATION

(71) Applicant: Prove Identity, Inc., New York, NY (US)

(72) Inventors: Uri J. Abraham, Buffalo Grove, IL (US); Patrick J. Flynn, Chicago, IL (US)

(21) Appl. No.: 18/185,605

(22) Filed: Mar. 17, 2023

(51) Int. Cl. H04W 12/06; H04W 12/72

(52) U.S. Cl. CPC H04W 12/06; H04W 12/72

(57) ABSTRACT

Briefly, example methods, apparatuses, and/or articles of manufacture may be implemented to conduct an authentication process of a subscriber via a communications device utilizing a method comprising initiating transmission of a forward instruction from a cellular transceiver to the communications device, in which the communications device is co-located with the subscriber. The method may continue with waiting for a response to the forward instruction from the subscriber and transmitting, from an authenticator to a client computing resource, one or more first signals to indicate whether the authenticator has obtained the response to the forward instruction. The method also includes determining whether to complete the authentication process of the subscriber based, at least in part, on the one or more first signals indicating that an expected confirming response, an unexpected response, or an expected declining response has been received from the communications device.

### BACKGROUND

### 1. Field

The present disclosure relates generally to techniques for the authentication of subscribers, such as subscribers utilizing communications devices having a messaging capability, such as via text, voice, or the like.

### 2. Information

The World Wide Web or simply the Web, as enabled by Internet computing, switching, and wireless and wireline transmission resources has grown rapidly in recent years at least partially in response to the ease with which a wide variety of electronic transactions can be performed. As a consequence of widely available Internet connections, including connections to the Internet facilitated by handheld wireless mobile communication services, for example, a mobile subscriber may shop and/or purchase virtually any product or service via a communications device. Beyond such Internet-enabled abilities to shop for products and services, a communications device may additionally be utilized to engage in financial and other types of transactions, which may include interacting with banks, brokerage houses, merchants, credit card issuers, healthcare service providers, etc. However, an unfortunate consequence of the widespread use of handheld communications devices to perform various types of transactions is that occurrences of fraud and deception have also increased in frequency.

In response to increases in occurrences of various types of fraud and deception involving use of handheld wireless communications devices, merchants, credit card issuers, healthcare providers, and other institutions, typically implement fraud-detection and/or user authentication processes. Such implementations may be utilized, for example, in connection with numerous types of web-based or electronic transactions or operations. Nonetheless, although fraud detection and/or user authentication processes may reduce instances of fraud and deception involving handheld electronic communications devices, unscrupulous individuals engaging in such activities continue to increase in skill and sophistication. Thus, it may be appreciated that reduction in the instances of fraud and deception, which may involve, for example, use of various types of communications devices, continues to be an active area of investigation.

### SUMMARY

One general aspect includes a method of conducting an authentication process of a subscriber via a communications device, the method including initiating transmission of a forward instruction from a cellular transceiver to the communications device, the communications device being co-located with the subscriber. The method also includes waiting for a response to the forward instruction from the subscriber. The method also includes transmitting, from an authenticator to a client computing resource, one or more first signals to indicate whether the authenticator has obtained the response to the forward instruction. The method also includes determining whether to complete the authentication process of the subscriber based, at least in part, on the one or more first signals indicating that an expected confirming response, an unexpected response, or an expected declining response has been received from the communications device.

In particular embodiments, prior to initiating transmission of the forward instruction from the cellular transceiver, the method may include obtaining one or more second signals to indicate the subscriber initiating a transaction. In particular embodiments, the expected declining response is based, at least in part, on a user interface of the communications device receiving input signals from the subscriber, the input signals to indicate one or more subscriber instructions not to complete the authenticating process. In particular embodiments, the unexpected response includes one or more alphanumeric characters, wherein at least one of the one or more alphanumeric characters is different from at least one expected alphanumeric character. In particular embodiments, the unexpected response includes a response from a cellular communications network to indicate that a response has not been received from the communications device during a predetermined time period. In particular embodiments, the method further includes the authenticator determining degradation of an audio signal from the communications device and, in response, transitioning to an exclusively text-based communications scheme between the communications device and the authenticator. In particular embodiments, the exclusively text-based communications scheme includes two-way communications between the communications device and the authenticator.

One general aspect includes an apparatus to conduct an authentication process of a subscriber via a communications device, including a processor coupled to at least one memory device to initiate transmission of a forward instruction from a cellular transceiver to the communications device, the communications device being co-located with the subscriber. In particular embodiments, the processor coupled to the at least one memory device is additionally to wait for a response to the forward instruction from the subscriber. In particular embodiments, the processor coupled to the at least one memory device is additionally to transmit, from an authenticator to a client computing resource, one or more first signals to indicate whether the authenticator has obtained the response to the forward instruction. In particular embodiments, the processor coupled to the at least one memory device is additionally to determine whether to complete the authentication process of the subscriber based, at least in part, on the one or more first signals, the one or more first signals to indicate that an expected confirming response, an unexpected response, or an expected declining response has been received from the communications device.

In particular embodiments, the processor coupled to the at least one memory device is additionally to, prior to initiating transmission of the forward instruction from the cellular transceiver, obtain one or more second signals to indicate the subscriber initiating a transaction. In particular embodiments, the expected declining response is to be based, at least in part, on a user interface of the communications device receiving input signals from the subscriber, the input signals to indicate one or more subscriber instructions not to complete the authentication process. In particular embodiments, the unexpected response is to include one or more alphanumeric characters, in which at least one of the one or more alphanumeric characters is different from at least one expected alphanumeric character. In particular embodiments, the unexpected response is to include a response from a cellular communications network to indicate a response has not been received from the communications device during a predetermined time period. In particular embodiments, the processor coupled to the at least one memory device is additionally to determine that degradation of an audio signal from the communications device has occurred and, in response, transition to an exclusively text-based communications scheme between the communications device and the authenticator. In particular embodiments, the exclusively text-based communications scheme includes two-way communications between the communications device and the authenticator.

One general aspect includes an article, which includes a non-transitory storage medium having instructions stored thereon executable by a processor of a special-purpose computing platform to initiate transmission of a forward instruction from a cellular transceiver to a communications device co-located with a subscriber. The stored instructions are additionally to wait for a response to the forward instruction from the subscriber. The stored instructions are additionally to transmit, from an authenticator to a client computing resource, one or more first signals to indicate whether the authenticator has obtained the response to the forward instruction. The stored instructions are additionally to determine whether to authenticate the subscriber based, at least in part, on the one or more first signals, in which the one or more first signals to indicate that an expected confirming response, an unexpected response, or an expected declining response has been received from the communications device.

In particular embodiments, the stored instructions executable by the special-purpose computing platform are additionally to, prior to initiating transmission of the forward instruction from the cellular transceiver, obtain one or more second signals to indicate the subscriber initiating a transaction. In particular embodiments, the expected declining response is to be based, at least in part, on a user interface of the communications device receiving input signals from the subscriber, the input signals to indicate one or more subscriber instructions not to complete an authentication process. In particular embodiments, the unexpected response is to include one or more alphanumeric characters and at least one of the one or more alphanumeric characters is different from at least one expected alphanumeric character. In particular embodiments, the unexpected response is to include a response from a cellular communications network to indicate that a response has not been received from the communications device during a predetermined time period. In particular embodiments, the stored instructions executable by the special-purpose computing platform are additionally to determine that degradation of an audio signal from the communications device has occurred and, in response, transition to an exclusively text-based communications scheme between the communications device and the authenticator. In particular embodiments, the exclusively text-based communications scheme includes two-way communications between the communications device and the authenticator.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a diagram of a communications infrastructure that includes both wireless and wireline communications devices and components, according to various embodiments.

FIG. 2 is a diagram of a subscriber in possession of a communications device to permit interaction between or among a client computing resource, an authenticator, and a messaging service, according to an embodiment.

FIG. 3 is a diagram showing message flow among a subscriber, a communications infrastructure, a client, an authenticator, and a messaging service, according to an embodiment.

FIG. 4 is a flowchart for a first process of subscriber authentication augmented by text messaging, according to an embodiment.

FIG. 5 is a flowchart for a second process of subscriber authentication augmented by text messaging, according to an embodiment.

FIG. 6 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

Throughout this specification, references to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, for the specification of a patent application, these and other issues have a potential to vary in a particular context of usage. In other words, throughout the disclosure, particular context of description and/or usage provides guidance regarding reasonable inferences to be drawn; however, likewise, the term “in this context” in general without further qualification refers at least to the context of the present patent application.

As previously alluded to, devices that communicate electronically, such as wireless mobile communications devices, voice-over-Internet-protocol (VOIP) communications devices, and devices representing the Internet of things (e.g., wireless sensors, wireless appliances, wireless industrial, commercial, and household machines, etc.) continue to increase in popularity. As these types of devices gain in popularity, a need to authenticate, verify, and/or validate users of such electronic communications devices also increases. Authentication of a subscriber associated with, affiliated with, and/or co-located with a communications device may be especially beneficial in environments that facilitate financial transactions utilizing wireless communications devices. Such transactions may involve completing applications for credit, engaging in electronic financial transactions, purchasing products and/or services, obtaining access to privileged content, completing loan applications, completing forms involved with applying for healthcare coverage (such as in connection with visiting a healthcare provider's office or otherwise requesting healthcare services), and/or engaging in a number of other types of transactions via a communications device. In other environments, such as environments involving IOT devices, authenticating subscribers co-located with wireless communications devices, and contacting such subscribers, may authorize remote access to various sensors, appliances, machines, and instruments, in which output signals from such devices may be utilized to drive numerous decision-making processes.

To facilitate transactions involving communications devices, and/or to obtain signal outputs from trusted communicating IOT devices, a subscriber co-located with, or otherwise affiliated with, a communications device may establish an identity. An identity may be established in connection with a subscriber account with a cellular or mobile wireless communications services carrier, a VoIP services provider, or other type of communication services carrier. Establishing an account associated with a communications device, utilizing, for example, a subscriber account identifier (e.g., a cellular telephone number, a universally unique identifier or UUID, etc.), may permit an individual attempting to engage in an electronic or digital transaction to be authenticated, authorized, and/or verified prior to engaging in the transaction. In other instances, an account associated with a communications device may operate to provide a measure of confidence that authorized individuals (exclusively) may obtain parameters from IOT devices and/or modify or influence operations of such IOT devices. In some instances, in view of the nature of electronic or digital transactions, which may take place within a communications infrastructure at any time and at any location, it may be useful to quickly verify and/or to authenticate subscriber co-located with a communications device. Such verification and/or authentication may perhaps occur in a real-time or near-real-time fashion.

In addition to authenticating a user of a communications device, which may facilitate a determination that a certain subscriber regularly or at least occasionally utilizes a certain communications device, it may be advantageous to request that a subscriber interact with his/her communications device while a transaction is in process, so as to increase certainty that the subscriber is cognizant of the ongoing transaction and to reaffirm that the subscriber wishes to continue with and/or complete the transaction. In some instances, responsive to a transaction involving a threshold amount of funds, credit, or otherwise being of greater importance and, thus, of a potentially greater risk than other types of transactions, additional affirmations may be useful in reducing fraudulent behavior and/or preventing the unscrupulous impersonation of a particular subscriber. Such additional affirmations may be of benefit to legitimate subscribers, such as by reducing the possibility of theft of funds belonging to the particular subscriber and may be of benefit to financial institutions, such as by reducing the risk of credit fraud, for example. Additional affirmations during a transaction may also be of benefit to content providers, such as by reducing an ability for nonpaying customers to obtain privileged content. Additional affirmations by a subscriber during certain types of financial transactions may bring about other benefits to subscribers and/or financial institutions, content providers, healthcare providers, and a variety of other entities and/or institutions, and claimed subject matter is not limited in this respect.

In other examples, such as environments in which IOT devices are retrieving, processing, and/or operating in response to retrieval and/or processing of measured parameters, authentication and/or verification of a communications device may be desirable as a means of verifying integrity of input signals and/or control settings, which may control or influence IOT devices. Authentication and/or verification of a communications device may involve establishing a bind between an authenticating entity and a real-world identity of a subscriber operating a communications device and/or a subscriber associated with one or more IOT devices. Further, for certain types of transactions involving IOT devices, additional affirmations supplied during transactions may provide assurance that control settings vital to the operation of an IOT device, or a system of IOT devices, are not improperly manipulated, biased, or engineered, in a manner that jeopardizes the operation of IOT devices. In other instances involving IOT devices, additional affirmations may operate to certify the integrity of output signals from such IOT devices, which may function to control particular types of downstream IOT devices.

In many contexts, a subscriber account identifier, which may exist in a digital domain, may operate to establish a persistent, continuing, and objectively verifiable correspondence or affiliation between a communications device and a subscriber in possession of, or at least associated with, a particular communications device. Thus, in a financial services environment, for example, a unique subscriber account identifier may be employed to signify and/or to identify a particular transacting party. In this context, the term “mobile communications device identity” and/or similar terms refer to an identity that leverages a mobile communications device account relationship of a subscriber as a source of authentication and/or verification of a transacting party. Also in this context, the term “mobile subscriber device account” and/or similar terms refer to a mobile communication services provider account. The terms “mobile communications device services provider,” “mobile communications device carrier,” and “mobile network operator” may be used interchangeably. Furthermore, in this context, the term “mobile device services carrier,” “communication services carrier,” “services carrier,” or simply “carrier” may refer to an entity operating within a communications infrastructure to provide wired and/or wireless communication services to the public for a consideration, such as a monthly subscription fee.

In the context of the present disclosure, a “communication services carrier” may refer to a mobile communication services provider and/or mobile network operator. However, there are examples of carriers that do not correspond to mobile communications device services providers and/or mobile network operators. Such instances may include wireline services providers (for example, providers of services that operate within the public switched telephone network or PSTN), which include wireline services for rotary-dial telephones and/or telephones utilizing, for example, dual tone multi-frequency (DTMF) signaling. In a given situation, particular context of usage should indicate if a term is being used in a general sense or in a narrower sense, such as referring to a mobile communications device services provider, wireline services provider, mobile paging services provider, and/or mobile network operator, for example.

Other aspects of verifying or authenticating a communications device (e.g., a mobile communications device, an IOT device, etc.) and/or augmenting authentication of a subscriber via text messaging are also described in greater detail hereinbelow. For example, in an embodiment, authenticating a subscriber or an owner of an IOT device, may bring about establishment of a bind between an individual and a mobile subscriber account. Further, a mobile subscriber account is merely an example approach toward establishing a correspondence between an individual and a communications device, and claimed subject matter is not intended to be limited to accounts established for mobile cellular communications devices and IOT devices. Rather, the term “account” or “subscriber account” in this context refers generally to a formal business arrangement between a provider of the account and an entity, a person, or other party seeking to obtain privileges associated with the account. Thus, the term “account” is intended to be broadly interpreted as an arrangement that may provide certain privileges. In this context, privileges may involve access to credit (e.g., so as to facilitate the present or future purchase of goods or services), access to privileged content (e.g., such as premium sports, cinema, or other entertainment content), access to healthcare services and/or healthcare records, access to financial records, access to financial and/or brokerage accounts, access to parameters transmitted by IOT devices, an ability to control operation of IOT devices, and so forth. In this context, the term “privileged content” is intended to be interpreted broadly so as to encompass any type of content available exclusively to certain individuals and/or certain entities in response to supplying certain credentials to a bank or financial institution, an IOT device, a mobile communication services provider, and so forth.

Also in this context, the term “forward instruction” refers to at least one message conveyed via a non-voice channel of a communications device, such as a text message channel of a mobile communications device, a text message channel of a VoIP device, or a text message channel of any other type of communications device. In such contexts, a “forward instruction” refers to an instruction to be executed by a subscriber of a communications device, such as an instruction to enter, via a user interface of a communications device, one of a plurality of selections. Examples of such selections may include relatively simple entries, such as “yes,” “no,” or “not sure.” In other examples, a forward instruction may comprise an instruction for a subscriber to enter an increasingly complex selection, such as entry of a portion of a subscriber's Social Security number, a subscriber's residential ZIP Code, a subscriber's city of birth, or any other instruction to prompt a subscriber to enter one or more alphanumeric parameters. In this context the term “alphanumeric” refers to characters of a standard alphabet (e.g., 26 characters of the English alphabet, 27 characters of the German alphabet, etc.) and numeric characters 0-9. Accordingly, for example, an alphanumeric response may comprise a single alphabetical character, such as “A,” multiple alphabetical characters, such as “ABCDE,” single or multiple numeric characters, such as “1,” or “123,” as well as combinations thereof, such as “ABC123 . . . ,” “A1B2C3 . . . .”

In the context of a mobile cellular communications device (e.g., a mobile cellular telephone), the term “subscriber account identifier” refers to a unique descriptor or feature associated with the account that defines certain aspects of the account. For example, in nonlimiting illustrations, a subscriber account identifier may refer to (or may at least be associated with) a mobile telephone number, a mobile subscriber unique alias, an International Mobile Subscriber Identifier (IMSI), Integrated Circuit Card Identifier (ICC ID), a mobile services and/or other type of identifier (e.g., a unique identifier) employed in connection with the particular mobile network operator or the mobile communication services provider. Mobile communications networks may include those compatible or compliant with a Global System for Mobile Communications (GSM) network, for example. Other examples of mobile subscriber account identifiers may include an International Mobile Equipment Identifier (IMEI), Mobile Station International Subscriber Directory Number (MSISDN), an international mobile subscriber identifier (IMSI), or any other identifier that may be utilized to identify a mobile billing account number/identifier. In the context of an IOT device, a combination of alphanumeric characters (which may function as a subscriber account identifier) may identify an individual authorized to receive or access parameters transmitted from the IOT device. The same or a different combination of alphanumeric characters may identify an individual authorized to modify/influence parameter settings of an IOT device. In particular embodiments, a subscriber account identifier may be utilized in combination with a “forward instruction,” as previously described herein, to provide additional insurance or affirmation that a certain subscriber is, indeed, in possession of a particular communications device.

In particular embodiments, a subscriber may initiate a transaction by contacting an institution, via a communications device co-located with the subscriber. An institution may comprise a bank, financial institution, creditor, healthcare provider, premium content provider, or the like, for example. In response, an institution, which may be a client of an authenticator, may contact the authenticator with a request for authentication and/or verification services with respect to the subscriber. Responsive to such request, an authenticator may transmit a forward instruction, such as via a messaging service (e.g., SMS message or any other type of message) to the subscriber via the subscriber's communications device. Responsive to receipt of the forward instruction, the subscriber may respond appropriately (e.g., “yes,” “no,” a ZIP Code, or a portion of a Social Security number, etc.). The messaging service may then forward the appropriate response to the authenticator. The authenticator may, in turn, determine whether the response provided by the subscriber comprises an “expected” response, or comprises an “unexpected” response. In this context, an “expected” response refers to a response that is within a finite set of predefined responses, which express whether a subscriber would like to proceed with a transaction. Thus, an expected response may comprise a response having alphanumeric characters that affirm, for example, that the subscriber is, indeed, attempting to engage in a financial transaction. An expected response may also comprise a negative response in which the subscriber may indicate that the subscriber is not currently engaged in a transaction or does not wish to further proceed toward completion of a transaction. In particular instances, an expected response that conveys one or more subscriber instructions to decline or to suspend a financial transaction, for example, may comprise an indication of an impersonator or other unscrupulous individual is presently attempting to defraud the subscriber and/or a financial institution.

In particular embodiments, in response to receipt of a forward instruction, a subscriber may enter an “unexpected” response, which may comprise a response that is other than an expected response. In this context, an unexpected response refers to a response that is outside of a finite set of predefined responses that express whether a subscriber would like to proceed with the transaction or would like to decline proceeding in a transaction. Thus, in keeping with the previous example, responsive to a set of expected responses being “yes,” “no,” or a ZIP Code, a portion of a Social Security number, an unexpected response may include responses that are outside of this set of expected responses. Accordingly, for example, an unexpected response may include responses such as, for example “maybe,” or with alphanumeric characters corresponding to an incorrect ZIP Code or alphanumeric characters corresponding to an incorrect portion of a social security number. An “unexpected” response may comprise an indication that a response has not been received within a predetermined duration (e.g., 20 seconds, 30 seconds, 1 minute, 5 minutes, 10 minutes, or more or less). In particular embodiments, responsive to an unexpected response comprising no response at all or comprising a response received outside of a predetermined duration, an authenticator may determine that a messaging service is no longer in voice contact with a subscriber. An unexpected response comprising no response at all may also occur in response to determining that the audio channel with the subscriber has degraded beyond a threshold value. In such an instance, an authenticator may transition to an exclusively text-only communications mode, in which a transaction, such as a financial transaction, is completed exclusively by way of a messaging capability, such as SMS, for example.

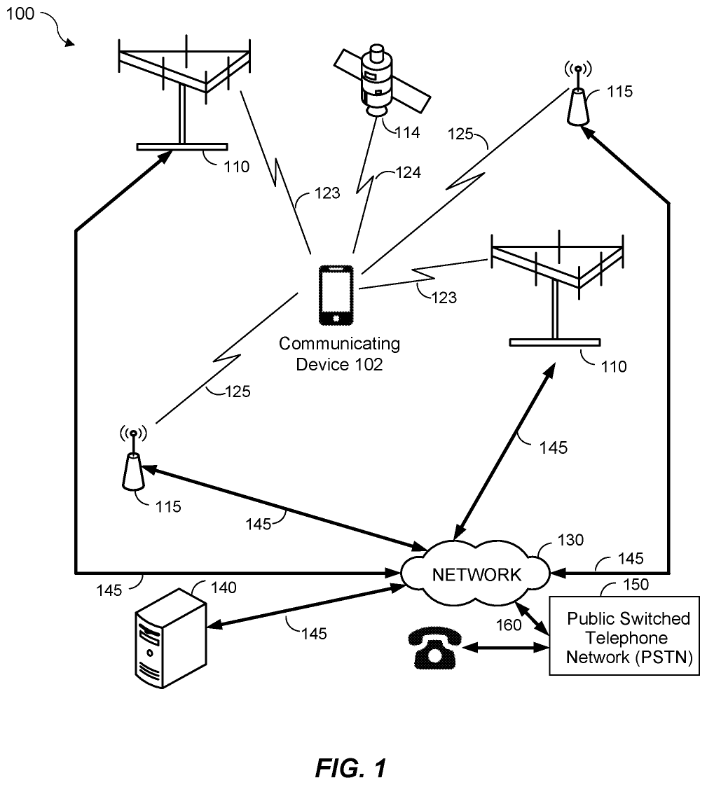

In FIG. 1, corresponding to embodiment 100, communications device 102 corresponds to a device designed primarily to conduct communications via cellular wireless, VoIP, or wireline means, such as to provide telephone communications, texting, web browsing, and so forth. Communications device 102 may additionally correspond to an IOT device, which may comprise any of a wide variety of devices, such as home automation devices (e.g., garage door openers, door locks, thermostats, etc.), Wireless Fidelity (Wi-Fi) enabled large appliances (e.g., washing machines, dryers, refrigerators, etc.), entertainment systems and components (e.g., televisions, stereos, etc.), wearable devices (e.g., smart watches, wearable insulin pumps, etc.), control devices (e.g., air conditioners, heaters, etc.), moisture sensors, humidity sensors, and a myriad of other control devices, sensing devices, monitoring devices, and claimed subject matter is not limited in this respect. In some instances, communications device 102 may provide a means of authenticating a subscriber, such as by way of an application program (or “app”) that executes via a processor of a mobile communications device, which operates to provide access to input signals of an IOT device or to provide access to output signals of an IOT device.

In the embodiment of FIG. 1, communications device 102 may transmit radio signals to, and receive radio signals from, a wireless communications network. In an example, communications device 102 may communicate with a cellular communications network by transmitting wireless signals to, and/or receiving wireless signals from, a cellular transceiver 110, which may comprise a wireless base transceiver subsystem, a Node B or an evolved NodeB (eNodeB), over wireless communication link 123. Similarly, communications device 102 may transmit wireless signals to, and/or receive wireless signals from, local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 110, local transceiver 115, satellite 114, and PSTN 150 represent touchpoints, which permit communications device 102 to interact with network 130.

Examples of network technologies that may support wireless communication link 123 are GSM, Code Division Multiple Access (CDMA), Wideband CDMA (WCDMA), Long Term Evolution LTE), High Rate Packet Data (HRPD). GSM, WCDMA, and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless communications network for a service (e.g., under a service contract). In the embodiment of FIG. 1, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, BT and LTE.

In a particular implementation, cellular transceiver 110 and local transceiver 115 may communicate with server 140, such as by way of network 130 via communication links 145. Here, network 130 may comprise any combination of wired or wireless links and may include cellular transceiver 110 and/or local transceiver 115 and/or server 140. In a particular implementation, network 130 may comprise Internet Protocol (IP) or other infrastructure capable of facilitating communication between communications device 102 at a call source and server 140 through local transceiver 115 or cellular transceiver 110. In an embodiment, network 130 may also facilitate communication between communications device 102, server 140 and a PSTN 150, for example through communications link 160. In another implementation, network 130 may comprise a cellular communication network infrastructure such as, for example, a base station controller or packet based or circuit based switching center (not shown) to facilitate mobile cellular communication with communications device 102. In a particular implementation, network 130 may comprise local area network (LAN) elements such as WiFi APs, routers and bridges and may, in such an instance, comprise links to gateway elements that provide access to wide area networks such as the Internet. In other implementations, network 130 may comprise a LAN and may or may not involve access to a wide area network but may not provide any such access (if supported) to communications device 102. In some implementations, network 130 may comprise multiple networks (e.g., one or more wireless networks and/or the Internet). In one implementation, network 130 may include one or more serving gateways or Packet Data Network gateways. In addition, one or more of server 140 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 130.

In particular embodiments, communications between communications device 102 and cellular transceiver 110, satellite 114, local transceiver 115, and so forth may occur utilizing signals communicated across wireless or wireline communications channels. Accordingly, the term “signal” may refer to communications utilizing propagation of electromagnetic waves or electronic signals via a wired or wireless communications channel. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in one or more signals using one or more of the above-identified modulation techniques.

In particular implementations, and as discussed below, communications device 102 may comprise circuitry and processing resources capable of obtaining location related measurements (e.g. for signals received from GPS or other Satellite Positioning System (SPS) satellites 114), cellular transceiver 110 or local transceiver 115 and possibly computing a position fix or estimated location of communications device 102 based on these location related measurements. In some implementations, location related measurements obtained by communications device 102 may be transferred to a location server such as an enhanced serving mobile location center (E-SMLC) or SUPL location platform (SLP) (e.g. which may comprise a server, such as server 140) after which the location server may estimate or determine an estimated location for communications device 102 based on the measurements. In the presently illustrated example, location related measurements obtained by communications device 102 may include measurements of signals 124 received from satellites belonging to an SPS or Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110).

Communications device 102 or a separate location server may obtain a location estimate for communications device 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at communications device 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at communications device 102. Here, server 140 may be capable of providing positioning assistance data to communications device 102 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, communications device 102 may obtain measurements of signal strengths for signals received from cellular transceiver 110 and/or local transceiver 115 and/or may obtain a round trip signal propagation time (RTT) between communications device 102 and a cellular transceiver 110 or local transceiver 115. A communications device 102 may use these measurements together with assistance data (e.g. terrestrial almanac data or GNSS satellite data such as GNSS Almanac and/or GNSS Ephemeris information) received from server 140 to determine a location estimate for communications device 102 or may transfer the measurements to server 140 to perform the same determination. A call from communications device 102 may be routed, based on the location of communications device 102, and connected to PSTN 150, for example, via wireless communication link 123 and communications link 160.

A mobile device at a call source (e.g., communications device 102 of FIG. 1) may be referred to by any name corresponding to a cellphone, smartphone, laptop, tablet, PDA, tracking device or some other portable or movable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network in which a user may employ audio, video and/or data I/O devices and/or body sensors and a separate wireline or wireless modem. An estimate of a location of a mobile device (e.g., communications device 102) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

Responsive to communications device 102 comprising a mobile cellular communications device, device 102 may comprise an embedded sensor suite which may, for example, include inertial sensors and environment sensors. Inertial sensors of communications device 102 may comprise, for example accelerometers (e.g., collectively responding to acceleration of communications device 102 in and x-direction, a y-direction, and a z-direction). Communications device 102 may further include one or more gyroscopes or one or more magnetometers (e.g., to support one or more compass applications). Environment sensors of communications device 102 may comprise, for example, temperature sensors, barometric pressure sensors, ambient light sensors, camera imagers, microphones, just to name few examples. Sensors of communications device 102 may generate analog or digital signals that may be stored in utilizing one or more memory locations internal to device 102 in support of one or more applications such as, for example, applications collecting or obtaining biometric attributes of a user (e.g., a subscriber) of communications device 102.

The architecture of the cellular communications network described in relation to FIG. 1 may comprise a generic architecture that is capable of accommodating a variety of outdoor and indoor location solutions including the standard SUPL user plane location solution defined by the Open Mobile Alliance (OMA) and standard control plane location solutions defined by 3GPP and 3GPP2. For example, server 140 may function as (i) a SUPL location platform to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

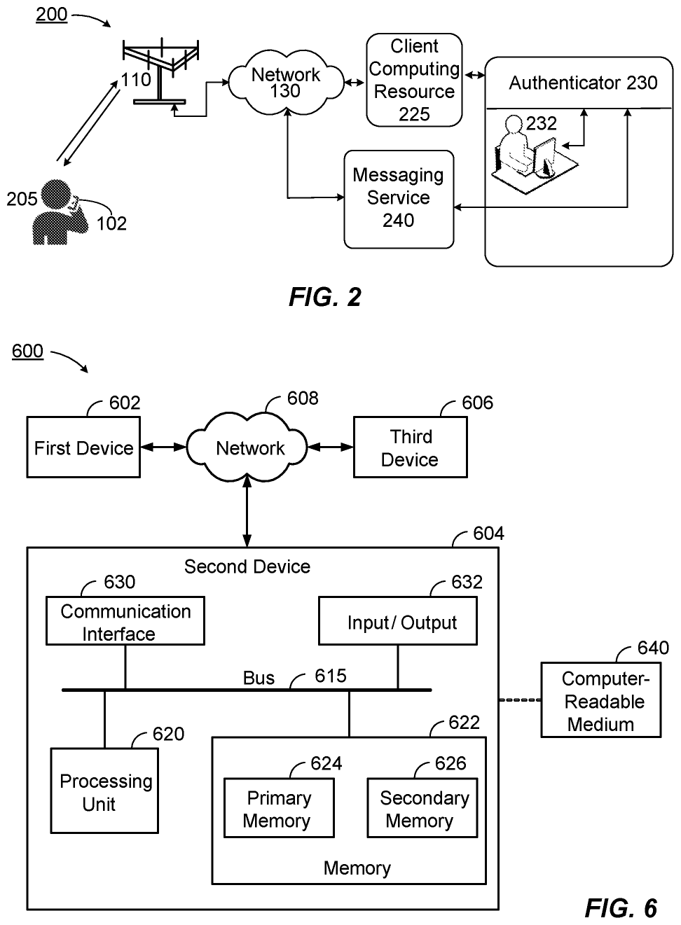

In view of the communications infrastructure shown and described in reference to FIG. 1, more particular embodiments directed toward subscriber authentication augmented by text messaging are discussed hereinbelow. Thus, in embodiment 200, as depicted in FIG. 2, subscriber 205 is shown in possession of a communications device to permit interaction between or among a client computing resource, an authenticator, and a messaging service, according to an embodiment. In FIG. 2, communications device corresponds to a mobile communications device, which may interact with client computing resource 225 and authenticator 230. In the embodiment of FIG. 2, mobile subscriber 205 and communications device 102 may be located at any point within communications range of cellular transceiver 110. As shown in FIG. 2, communications device 102 may communicate with client computing resource 225 via network 130 utilizing a wireless communications channel between the communications device and cellular transceiver 110. It should be noted, however, that claimed subject matter is not limited exclusively to wireless communications between communications device 102 and cellular transceiver 110. For example, in particular embodiments, communications device 102 may communicate with client computing resource 225 by way of one or more intervening Wi-Fi networks or by way of wireline telephone services (e.g., the public switched telephone network).

Subscriber 205, utilizing communications device 102, may attempt to engage in a financial transaction via client computing resource 225. Client computing resource 225 may operate under the control or influence of a bank (or other type of financial institution), a real estate title company, a healthcare provider, a content provider, or any other type of entity that may, at least from time to time, require verification, authentication, and/or auditing of communications device 102 prior to permitting a transaction to take place. In an alternative embodiment, communications device 102 may represent an IOT device, which may operate to transmit output signals representing, for example, sensor measurements, which may be utilized by a client computing resource, which may facilitate decision-making processes other than those of a financial nature, such as to support processes involving, for example, other types of IOT devices.

Subscriber 205 may operate communications device 102 to initiate a transaction involving client computing resource 225. In response to subscriber 205 attempting to engage in a financial transaction, client computing resource 225 may communicate with authenticator 230, which may operate to authenticate, verify, and/or audit subscriber 205 operating communications device 102. In the embodiment of FIG. 2, authentication, verification, and/or auditing of subscriber 205 may include authenticator 230, such as under the control of operator 232, accessing a device database, which may relate to signals indicating a record of historical occurrences with respect to communications device 102. Such signals may be regarded by client computing resource 225 as contributing to overall trustworthiness of subscriber 205. In particular embodiments, client computing resource 225 may assess trustworthiness of subscriber 205 by obtaining signals to indicate whether (and/or how often) subscriber 205 has ported communications device 102, such as to obtain a new subscriber identifier (e.g., a mobile telephone number). Client computing resource 225 may assess trustworthiness of subscriber 205 by obtaining signals to indicate whether subscriber 205 has recently removed/replaced a SIM of a communications device. Client computing resource 225 may assess trustworthiness of subscriber 205 via obtaining signals indicating occurrences of password resets, such as implemented via transmission of one-time passwords to communications device 102. Client computing resource 225 may assess trustworthiness of subscriber 205 by obtaining signals representing tenure of communications device 102, which may relate to a duration that subscriber 205 has owned, operated, or has otherwise been affiliated with device 102. It should be noted that claimed subject matter is intended to embrace additional contributors to a trustworthiness score or trustworthiness measure, virtually without limitation.

In the embodiment of FIG. 2, prior to permitting subscriber 205 to complete a financial transaction via client computing resource 225, authenticator 228 may establish or form a non-voice (e.g., text) communications channel between itself and communications device 102. Accordingly, responsive to operator 232 losing voice contact, or determining degraded voice quality with subscriber 205, authenticator 230 may instruct messaging service 240 to communicate directly with communications device 102 via network 130. Messaging 240 may comprise a capability to generate and receive SMS messages to and from communications device 102, or may communicate via, for example, i-messages, or by way of any other messaging protocol. In an embodiment, messaging service 240 may generate a forward instruction to communications device 102 which may, for example, request that subscriber 205 enter one of the plurality of expected responses. In a particular embodiment, an expected “yes” to indicate that subscriber 205 is, indeed, engaging in a financial transaction. In particular embodiments, based, at least in part, on a type of transaction, authenticator 230 may request in one or more additional affirmations from subscriber 205. For example, in response to client computing resource determining that a monetary amount of a certain transaction corresponds to a value above a particular threshold, authenticator 230 may request messaging service 240 to generate additional requests for affirmation. One or more requests for additional affirmation may be based, at least in part, on other criteria, and claimed subject matter is not limited in this respect.

Authenticator 230 may instruct messaging service to transmit a forward instruction to subscriber 205, such as to enter an expected response of “no” to indicate that subscriber 205 is not currently engaged in performing a financial transaction. In particular embodiments, messaging service 240 may initiate or perform a timing function, in which the messaging service 240 closes a messaging session involving communications device 102 responsive to no response from communications device 102 being received within a predetermined interval (e.g., 20 seconds, 30 seconds, 1 minute, 5 minutes, 10 minutes, or more or less). In particular embodiments, responsive to expiration of a predetermined interval without receipt of a response from subscriber 205, authenticator 230 may suspend attempts at further voice communication with subscriber 205. In such instances, authenticator 230 may communicate exclusively with subscriber 205 operating communications device 102 via a non-voice or exclusively text-only messaging. Non-voice or exclusively text-only or communications may be continued until the transaction between subscriber 205 and client computing resource 225 is complete.

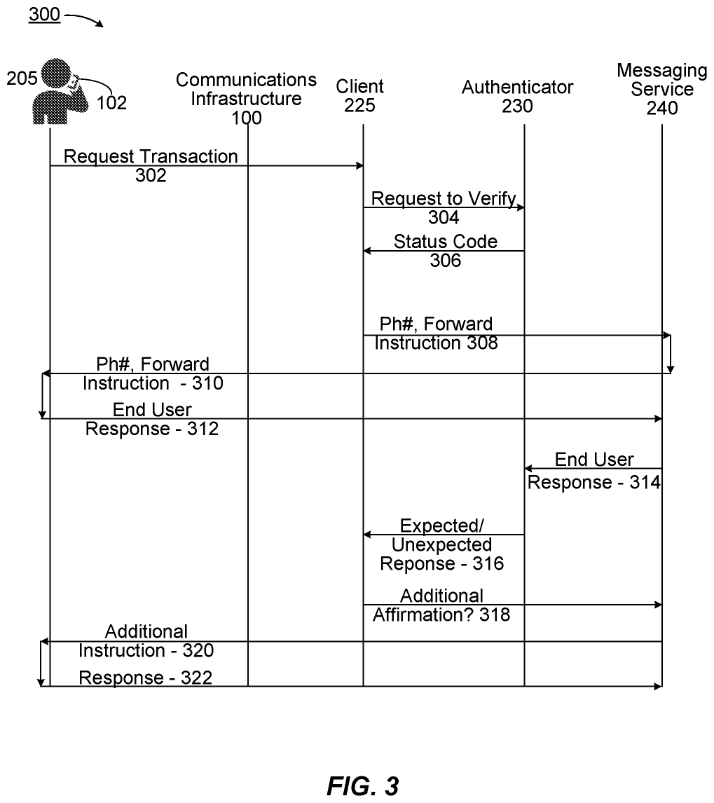

FIG. 3 is a diagram showing message flow among a subscriber, a communications infrastructure, a client, an authenticator, and a messaging service, according to an embodiment 300. As shown in FIG. 3, subscriber 205, operating and/or co-located with communications device 102, utilizes communications infrastructure to contact client computing resource 225 at 302. In particular embodiments, client computing resource 225 may comprise a financial institution, a healthcare services provider, a premium content provider, or may comprise an operator of one or more IOT devices, for example. Responsive to subscriber 205 contacting client computing resource 225, the client may generate and transmit a request, at 304, for authenticator 230 to authenticate the transaction. At 306, authenticator 230 may generate status code 306 and transmit the status code to client computing resource 225. In an embodiment, status code 306 may indicate that a transaction is in process.

At 308, in response to status code 306 being transmitted to client computing resource 225, client computing resource 225 may transmit a phone number, or other type of subscriber identifier, to authenticator 230 for forwarding to messaging service 240. In addition, client computing resource 225 may transmit an additional message, which may comprise a forward instruction, to indicate a message to be forwarded to subscriber 205. In turn, messaging service 240 may transmit the forward instruction via communications infrastructure 100 to communications device 102 utilizing the phone number or other subscriber identifier provided by client computing resource 225.

Forward instruction 308 of FIG. 3 may correspond to an instruction to direct an activity of subscriber 205 co-located with communications device 102. In an embodiment, forward instruction 308 may comprise a request for subscriber 205 to enter a fairly simple response via a user interface of communications device 102. For example, in the embodiment of FIG. 3, a forward instruction may pose a question to subscriber 205 such as “Are you currently engaged in a transaction with your bank-account ending in 1234? Enter “Yes” or “No.” A forward instruction may comprise an instruction to prompt any other activity on the part of subscriber 205, and claimed subject matter is not limited in this respect. Responsive to receipt of forward instruction 310, subscriber 205 may enter an appropriate response (e.g., “Yes” or “No) for transmission to messaging service 240 such as at 312. In turn, messaging service 240 may forward the response to authenticator 230, such as at 314. Authenticator 230 may, in turn, forward the received response to client computing resource 225, such as at 316. Client computing resource 225 may request additional affirmations, such as at 318, responsive to business rules and/or business logic employed by client computing resource 225. For example, responsive to subscriber 205 initiating a transaction for a relatively large monetary amount, client computing resource 225 may request an additional affirmation, such as at 318. A request for an additional affirmation may be transmitted by messaging service 240, such as at 320, and a second response may be received responsive to such a request, such as at 322.

Returning to 316 of FIG. 3, certain responses from a subscriber (e.g., subscriber 205) may correspond to expected versus unexpected responses. For example, as previously discussed herein, at 308, client computing resource 225 may transmit forward instruction 308 and may wait for an expected (alphanumeric) response corresponding to a “Yes” or a “No.” Client computing resource 225 may wait for other expected responses, such as particular parameters relative to subscriber 205 (e.g., a portion of a Social Security number, ZIP Code, etc.). Similarly, certain responses from a subscriber (e.g., subscriber 205) may comprise alphanumeric characters that form an unexpected response, such as, just as one possible example, “Who is this?,” “What?,” or “How did you get this number?” In addition, at least in particular embodiments, a failure to receive any response may qualify as an unexpected response. For the case of expected declining responses, which indicate one or more subscriber instructions not to proceed with a transaction, such as evidenced by receipt of a “No” from subscriber 205, client computing resource 225 may terminate an initiated transaction. Further, for the case of receiving alphanumeric characters that form unexpected responses, such as “Who is this?” “What?” or “How did you get this number?,” client computing resource 225 may also terminate an initiated transaction.

In particular embodiments, a failure to receive any response from subscriber 205 (via communications device 102) may be indicative of an inoperative or degraded voice channel, in which, for example, a voice communication from subscriber 205 cannot be heard, or cannot be heard with acceptable clarity. In such instances, authenticator 230 may resort to communications conducted exclusively via text messages (e.g., SMS messaging). In such instances, as a contingency, an exclusively text-based communications mode, such as at 460, which may permit subscriber 205 to complete a transaction involving client computing resource 225.

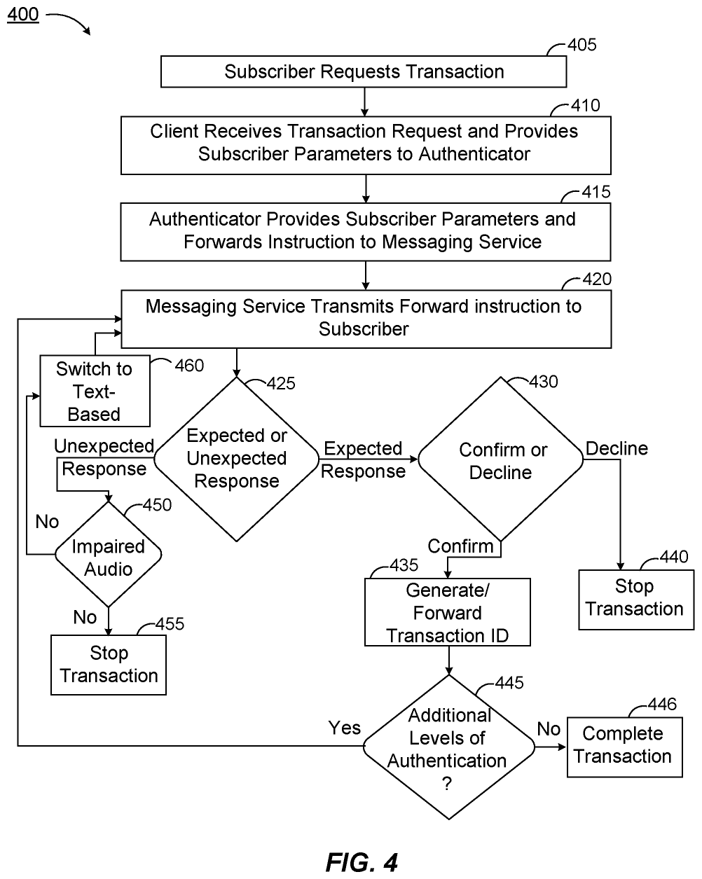

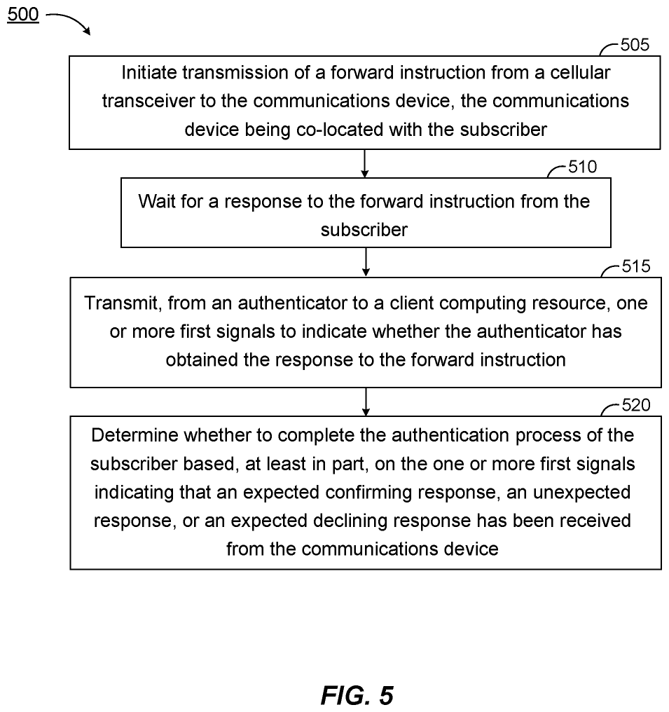

FIG. 4 is a flowchart for a first process of subscriber authentication augmented by text messaging, according to an embodiment 400. It should be noted that the process represented by the flowcharts of FIGS. 4 and 5 may include actions in addition to those depicted in the figure and/or may include actions arranged in an order different than shown in FIG. 4. The method of FIG. 4 may begin at 405, in which a subscriber, such as subscriber 205 of FIG. 2, requests a transaction from, for example, a financial institution. At 410, a client, which may comprise the financial institution, receives the transaction requests and communicates with an authenticator (e.g., authenticator 230). At 415, the authenticator provides subscriber parameters and forwards an instruction to a messaging service (e.g., messaging service 240). At 420, the messaging service transmits a forward instruction, via a communications infrastructure, to a communications device co-located with a subscriber.

At 425, an authenticator waits for an alphanumeric expected or an unexpected response. Responsive to the authenticator receiving an expected response, 430 may be performed in which the expected response is analyzed to determine if the expected response conveys a confirmation message or a message to decline a transaction. Responsive to the expected response conveying a message to decline the transaction, the transaction may be stopped at 440. Responsive to the expected response conveying the message to confirm the transaction, 435 may be performed, which includes generating and forwarding a transaction identification to the client. At 445, a client may determine whether additional levels of affirmation are to be obtained. Responsive to a client determining that additional affirmations are to be obtained, control may return to 420, in which a messaging service transmits another forward instruction to a subscriber. Responsive to a client determining that additional affirmations are not to be obtained, 446 may be performed, in which the client permits the transaction to complete.

Returning briefly to 425, in response to receipt of an unexpected response, such as in accordance with unexpected responses previously described herein and/or no response having been received (including receipt of a response outside of a predetermined duration), an authenticator may determine whether an audio channel between a client and a subscriber is degraded or impaired, such as at 450. Responsive to a degraded or impaired audio communications channel not being detected, a client may infer that a potentially fraudulent transaction is in process and, consequently, stop the transaction at 455. Responsive to a degraded or impaired audio communications channel being detected, a client may transition to an exclusively text-based approach toward completing a transaction. In such case, control may return to 420.

FIG. 5 is a flowchart for a second process of subscriber authentication augmented by text messaging, according to an embodiment 500. The method may begin at 505, which may include initiating transmission of a forward instruction from a cellular transceiver to a communications device, wherein the communications device is co-located with a subscriber. At 505, the forward instruction may be generated by a messaging service prior to transmission of the instruction from the cellular transceiver. The method may continue at 510, which may include waiting for a response, such as from the subscriber, to the forward instruction. The method may continue at 515, which may include transmitting, from an authenticator to a client computing resource, one or more first signals to indicate whether the authenticator has obtained the response to the forward instruction. The method may continue at 520, wherein a client may determine whether to complete an authentication process of the subscriber based, at least in part, on the one or more first signals indicating that an expected confirming response, an unexpected confirming response, or an expected declining response has been received from the communications device.

FIG. 6 is a diagram showing a computing environment, according to an embodiment 600. In the embodiment of FIG. 6, first and third devices 602 and 606 may be capable of rendering a graphical user interface (GUI) for a network device, such as server device 140 of FIG. 1, so that a subscriber utilizing a communications device (e.g., a mobile cellular communications device, an IOT device, etc.) may engage in system use. Device 604 may potentially serve a similar function in this illustration. Likewise, in FIG. 6, computing device 602 (‘first device’ in FIG. 6) may interface with computing device 604 (‘second device’ in FIG. 6), which may, for example, also comprise features of a client computing device and/or a server computing device, in an embodiment. Processor (e.g., processing device) 620 and memory 622, which may comprise primary memory 624 and secondary memory 626, may communicate by way of a communication interface 630, for example. The term “computing device,” or “computing resource” in the context of the present patent application, refers to a system and/or a device, such as a computing apparatus that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 604, as depicted in FIG. 6, is merely one example, and claimed subject matter is not limited in scope to this particular example.

In FIG. 6, computing device 602 may provide one or more sources of executable computer instructions in the form of physical states and/or signals (e.g., stored in memory states), for example. Computing device 602 may communicate with computing device 604 by way of a network connection, such as via network 608, for example. As previously mentioned, a connection, while physical, may be virtual while not necessarily being tangible. Although computing device 604 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 622 may comprise any non-transitory storage mechanism. Memory 622 may comprise, for example, primary memory 624 and secondary memory 626, additional memory circuits, mechanisms, or combinations thereof may be used. Memory 622 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may comprise one or more articles utilized to store a program of executable computer instructions. For example, processor 620 may fetch executable instructions from memory and proceed to execute the fetched instructions. Memory 622 may also comprise a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), comprising, for example, a program of executable computer instructions, may be executed by processor 620 and able to generate signals to be communicated via a network, for example, as previously described. Generated signals may also be stored in memory, also previously suggested.

Memory 622 may store electronic files and/or electronic documents, such as relating to one or more users, and may also comprise a machine-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 620 may comprise one or more circuits, such as digital circuits, to perform at least a portion of a computing procedure and/or process. By way of example, but not limitation, processor 620 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including a component 632 operable with input/output devices, and communication bus 615, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more communications devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a client computing device and/or a communications device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a communications device and/or a client computing device in various embodiments. Network devices capable of operating as a client computing device, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a communications device, as well as other types of devices, including between wired and/or wireless devices coupled via a wired and/or wireless network, for example, or any combination thereof. It is noted that the terms, server, server device, server computing device, server computing platform and/or similar terms are used interchangeably.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communications devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

The term electronic file and/or the term electronic document are used throughout this document to refer to a set of stored memory states and/or a set of physical signals associated in a manner so as to thereby, at least logically, form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a subscriber, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as IOS, Android, Windows Mobile, and/or the like. A computing device and/or network device may include and/or may execute a variety of possible applications, such as a communications device application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method of conducting an authentication process of a subscriber via a communications device, the method comprising:
initiating transmission of a forward instruction from a cellular transceiver to the communications device, the communications device being co-located with the subscriber;
waiting for a response to the forward instruction from the subscriber;
transmitting, from an authenticator to a client computing resource, one or more first signals to indicate whether the authenticator has obtained the response to the forward instruction; and
determining whether to complete the authentication process of the subscriber based, at least in part, on the one or more first signals indicating that an expected confirming response, an unexpected response, or an expected declining response has been received from the communications device.

2. The method of claim 1, further comprising:
prior to initiating transmission of the forward instruction from the cellular transceiver, obtaining one or more second signals to indicate the subscriber initiating a transaction.

3. The method of claim 1, wherein the expected declining response is based, at least in part, on a user interface of the communications device receiving input signals from the subscriber, the input signals to indicate a subscriber instruction not to complete the authenticating process.

4. The method of claim 3, wherein the unexpected response comprises one or more alphanumeric characters and wherein at least one of the one or more alphanumeric characters is different from at least one expected alphanumeric character.

5. The method of claim 1, wherein the unexpected response comprises a response from a cellular communications network to indicate that a response has not been received from the communications device during a predetermined time period.

6. The method of claim 1, further comprising the authenticator determining degradation of an audio signal from the communications device and, in response, transitioning to an exclusively text-based communications scheme between the communications device and the authenticator.

7. The method of claim 6, wherein the exclusively text-based communications scheme includes two-way messaging communications between the communications device and the authenticator.

8. An apparatus to conduct an authentication process of a subscriber via a communications device, comprising:
a processor coupled to at least one memory device to:
initiate transmission of a forward instruction from a cellular transceiver to the communications device, the communications device being co-located with the subscriber;
wait for a response to the forward instruction from the subscriber;
transmit, from an authenticator to a client computing resource, one or more first signals to indicate whether the authenticator has obtained the response to the forward instruction; and to
determine whether to complete the authentication process of the subscriber based, at least in part, on the one or more first signals, the one or more first signals to indicate that an expected confirming response, an unexpected response, or an expected declining response has been received from the communications device.

9. The apparatus of claim 8, wherein the processor coupled to the at least one memory device is additionally to:
prior to initiating transmission of the forward instruction from the cellular transceiver, obtain one or more second signals to indicate the subscriber initiating a transaction.

10. The apparatus of claim 8, wherein the expected declining response is to be based, at least in part, on a user interface of the communications device receiving input signals from the subscriber, the input signals to indicate one or more subscriber instructions the authentication process.

11. The apparatus of claim 10, wherein the unexpected response is to comprise one or more alphanumeric characters and wherein at least one of the one or more alphanumeric characters is different from at least one expected alphanumeric character.

12. The apparatus of claim 8, wherein the unexpected response is to comprise a response from a cellular communications network to indicate that a response has not been received from the communications device during a predetermined time period.

13. The apparatus of claim 8, wherein the processor coupled to the at least one memory device is additionally to:
determine that degradation of an audio signal from the communications device has occurred and, in response, transition to an exclusively text-based communications scheme between the communications device and the authenticator.

14. The apparatus of claim 13, wherein the exclusively text-based communications scheme includes two-way communications between the communications device and the authenticator.

15. An article comprising:
a non-transitory storage medium having instructions stored thereon executable by a processor of a special-purpose computing platform to:
initiate transmission of a forward instruction from a cellular transceiver to a communications device co-located with a subscriber;
wait for a response to the forward instruction from the subscriber;
transmit, from an authenticator to a client computing resource, one or more first signals to indicate whether the authenticator has obtained the response to the forward instruction; and to
determine whether to authenticate the subscriber based, at least in part, on the one or more first signals, the one or more first signals to indicate that an expected confirming response, an unexpected response, or an expected declining response has been received from the communications device.

16. The article of claim 15, wherein the instructions executable by the special-purpose computing platform are additionally to:
prior to initiating transmission of the forward instruction from the cellular transceiver, obtain one or more second signals to indicate the subscriber initiating a transaction.

17. The article of claim 15, wherein the expected declining response is to be based, at least in part, on a user interface of the communications device receiving input signals from the subscriber, the input signals to indicate one or more subscriber instructions not to complete an authentication process.

18. The article of claim 17, wherein the unexpected response is to comprise one or more alphanumeric characters and wherein at least one of the one or more alphanumeric characters is different from at least one expected alphanumeric character.

19. The article of claim 15, wherein the unexpected response is to comprise a response from a cellular communications network to indicate that a response has not been received from the communications device during a predetermined time period.

20. The article of claim 15, wherein the instructions executable by the special-purpose computing platform are additionally to:
determine that degradation of an audio signal from the communications device has occurred and, in response, transition to an exclusively text-based communications scheme between the communications device and the authenticator.

21. The article of claim 20, wherein the exclusively text-based communications scheme includes two-way communications between the communications device and the authenticator.
